(19) United States
(12) Patent Application Publication
(10) Pub. No.: US 2025/0232202 A1
(43) Pub. Date: Jul. 17, 2025

(54) FREQUENCY MULTIPLEXED ALL-OPTICAL COHERENT ISING MACHINE

(71) Applicant: NTT RESEARCH, INC., Sunnyvale, CA (US)

(72) Inventors: Myoung-gyun SUH, Sunnyvale, CA (US); Yonghwi KIM, Sunnyvale, CA (US)

(73) Assignee: NTT RESEARCH, INC., Sunnyvale, CA (US)

(21) Appl. No.: 18/853,175

(22) PCT Filed: Apr. 7, 2023
(86) PCT No.: PCT/US2023/065531

§ 371 Date: Oct. 1, 2024

Related U.S. Application Data
(60) Provisional application No. 63/328,919, filed on Apr. 8, 2022.

(51) Int. Cl. G06N 10/60; G06N 10/40

(52) U.S. Cl. CPC G06N 10/60; G06N 10/40

(57) ABSTRACT

In some embodiments, an all-optical Coherent Ising Machine (CIM) may be provided. The all optical CIM may include a fiber optics component configured to enable a frequency domain multiplexing by providing a transmission medium for a plurality of comb lines of a frequency comb mapped into a spin vector; a free space optics component configured to enable a spatial domain multiplexing by spatially separating the plurality of comb lines of the frequency comb; and a spatial light modulator configured to encode a spin-spin interaction matrix and allowing for a vector matrix multiplication, in an optical domain, of the spatially separated plurality of comb lines mapped to the spin vector and the spin-spin interaction matrix, wherein the result of the vector matrix multiplication provides a linear feedback to solve an Ising problem.

This application claims priority to U.S. Provisional Application No. 63/328,919, filed Apr. 8, 2022 and entitled “Frequency Multiplexed All-Optical Coherent Ising Machine,” which has been hereby incorporated in its entirety by reference.

### BACKGROUND

An Ising Machine is a special-purpose physical system for finding the minimum energy spin configurations of an Ising Hamiltonian. An Ising Hamiltonian models the energy of a spin system based on the interactions between neighboring spins, where the interactions may be augmented by another function. Furthermore, the Ising Hamiltonian may have a bias term, which may be an external force field that may affect the aforementioned interactions between the neighboring spins. For example, FIG. 1 depicts a two-dimensional Ising model 100 of spin-spin interaction, as known in the art. To represent the energy of the Ising model 100 of spin-spin interaction, an example Ising Hamiltonian may have has the following mathematical form.

$$H ( σ ) = - {\sum }_{( i , j )} {J}_{i j} {σ}_{i} {σ}_{j} - μ {\sum }_{j} {h}_{j} {σ}_{j}$$

In the Hamiltonian H(σ), σᵢ mathematically represents the orientation of i-th spin (up or down) and Jᵢⱼ represents a matrix with elements that augment (or influence) the interactions between i-th spin and j-th spin. An external bias field component hⱼ may also influence a corresponding spin σⱼ. Solving the aforementioned Ising problem involves minimizing the Hamiltonian H(σ), i.e., finding an optimal spin configuration of σᵢ given the Jᵢⱼ matrix such that the mathematical expression is minimized. Ising Machines can be used to solve combinatorial optimization problems, which, while being hard to solve using conventional computers, can be mapped directly into Ising models.

FIG. 2 depicts an example of an Ising Machine 204, as known in the art. The shown Ising Machine 204 may be based on a hybrid approach: having an optical part 206 and an electronic part 208. Because the optical part 206 uses coherence of laser pulses for information encoding (spin up/down information is encoded in the phase of optical pulses), the Ising Machine 204 can be referred to as a Coherent Ising Machine (CIM) 204. The CIM 204 may use a network of optical parametric oscillators (OPOs) as shown in the optical parts 206, in which the strongest collective mode of oscillation above a threshold corresponds to an optimum solution of a given Ising problem. The electronic part 208, generally built using a field programmable gate array (FPGA) may provide a linear feedback loop providing a vector matrix multiplication of the Jᵢⱼ matrix and the vector representing the spins σᵢ in an attempt to reach the optimum solution. There have been other types of Ising Machines in addition to the hybrid CIM 204: some Ising Machines are all-electronic and other Ising Machines are all-optical. Regardless of the modality of the Ising Machines, they are generally time multiplexed.

Conventional time-multiplexed CIMs, however, have several technical shortcomings. Time-multiplexing alone does not allow conventional CIM to perform parallel encoding of N spins; instead, the encoding has to be performed in a step-by-step fashion at successive points in time. Furthermore, it is difficult for conventional CIMs to support parallel interaction of N*N Jᵢⱼ matrix elements with the spins because a support for the parallelism necessarily requires serial-parallel conversion, e.g., from serially encoded spins to a parallel configuration. Because of these limitations, e.g., serially encoded spins and the bottleneck requirement for serial-parallel conversion, conventional CIMs have remained low bandwidth while consuming relatively high power.

As such, a new architecture of CIMs supporting parallel processing is therefore desired.

### SUMMARY

In some embodiments, an all-optical Coherent Ising Machine (CIM) may be provided. The all optical CIM may include a fiber optics component configured to enable a frequency domain multiplexing by providing a transmission medium for a plurality of comb lines of a frequency comb mapped into a spin vector; a free space optics component configured to enable a spatial domain multiplexing by spatially separating the plurality of comb lines of the frequency comb; and a spatial light modulator configured to encode a spin-spin interaction matrix and allowing for a vector matrix multiplication, in an optical domain, of the spatially separated plurality of comb lines mapped to the spin vector and the spin-spin interaction matrix, wherein the result of the vector matrix multiplication provides a linear feedback to solve an Ising problem.

In some embodiments, a method of solving an Ising problem is provided. The method may include enabling, by a fiber optics component, frequency domain multiplexing by providing a transmission medium for a plurality of comb lines of a frequency comb mapped into a spin vector; enabling, by a free space optics component, a spatial domain multiplexing by spatially separating the plurality of comb lines of the frequency comb; and allowing, by a spatial light modulator encoding a spin-spin interaction, a vector matrix multiplication, in an optical domain, of the spatially separated plurality of comb lines mapped to the spin vector and the spin-spin interaction matrix, wherein the result of the vector matrix multiplication provides a linear feedback to solve the Ising problem.

### BRIEF DESCRIPTION OF DRAWINGS

FIG. 1 depicts a two-dimensional Ising model of spin-spin interaction, as known in the art.

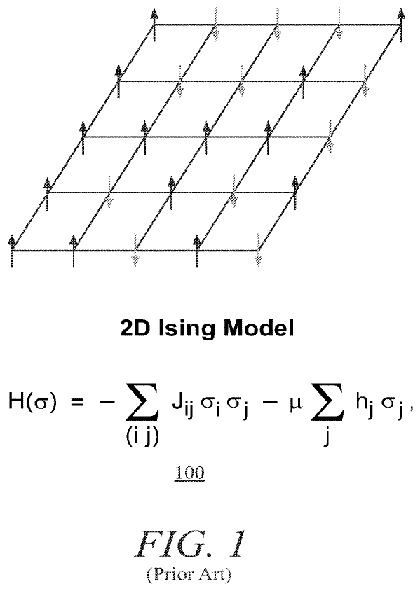

FIG. 2 depicts an example of an Ising Machine, as known in the art.

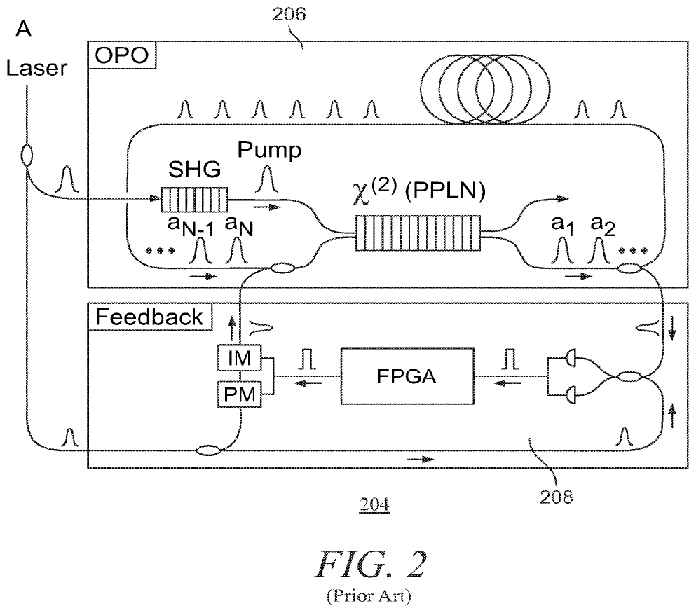

FIG. 3 depicts an illustrative an all-optical CIM, according to example embodiments of this disclosure

FIG. 4 depicts an information mapping using optical frequency combs.

FIG. 5 depicts a process of spatially dispersing optical frequency combs in two-dimensions, as known in the art.

FIG. 6A depicts a process of generating a two-dimensional spectral shower, as known in the art.

FIG. 6B depicts a process of generating a two-dimensional spectral shower, as known in the art.

FIG. 7 depicts an operation of a phase change material (PCM), as known in the art.

FIG. 8 depicts the changes in electrical and optical properties of PCM based on temperature, as known in the art.

FIG. 9 depicts an illustrative electrical readout scheme of PCM states, according to example embodiments of this disclosure.

FIG. 10 depicts an illustrative multiple heterodyne (dual-comb) readout of the solution of the Ising problem, according to example embodiments of this disclosure.

FIG. 11 depicts an illustrative process of a time domain multiplexing, according to example embodiments of this disclosure.

FIG. 12 depicts an illustrative process of an additional spatial domain multiplexing, according to example embodiments of this disclosure.

FIG. 13 depicts a flow diagram of an illustrative method implemented by an all-optical CIM, according to example embodiments of this disclosure.

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments disclosed herein may solve the aforementioned technical problems and may provide other solutions as well. An example all-optical Coherent Ising Machine (CIM) is described. The all-optical CIM may use fiber optics to transmit a frequency comb for enabling frequency domain multiplexing and free space optics to spatially separate the frequencies for enabling spatial domain multiplexing. The vector matrix multiplication may be performed optically in a spatial light modulator (SLM) that encodes the Jᵢⱼ matrix, which is a spin-spin interaction matrix indicating an influence of a spin to other spins in the CIM. Because the frequencies are spatially separated, multiplication of the spin information encoded in the frequencies may be performed in parallel with different portions of the spin-spin interaction matrix. The result of the vector matrix multiplication may be captured by an array formed by phase change material (PCM), and the result may be used to control the optical feedback loop. A convergence of the phases of the individual pixels of the PCM can be considered a solution to the Ising problem. Additional time domain multiplexing may be provided in between Ising computations by setting and resetting phase changes within the result array. Additional spatial domain multiplexing may be provided by additional fiber optics and free space optics. Therefore, by incorporating multiple layers of multiplexing, the disclosed all-optical CIM may provide high bandwidth while consuming low power.

The all-optical CIM may provide frequency domain multiplexing through frequency combs encoding spin information, wherein the frequency combs are transmitted through optical fibers. Free space optical components may provide spatial division multiplexing by spatially separating the frequencies in the frequency combs. A spatial light modulator may be used load the spin-spin interaction matrix and the vector matrix multiplication may be performed in the optical domain utilizing the parallelism provided by the spatial separation of the frequencies. A PCM array may capture the result of the vector matrix multiplication and use the result to control the feedback loop in the fiber optics cavity. When the results converge, the phases of the pixels in the PCM array may read as a solution to the corresponding Ising problem

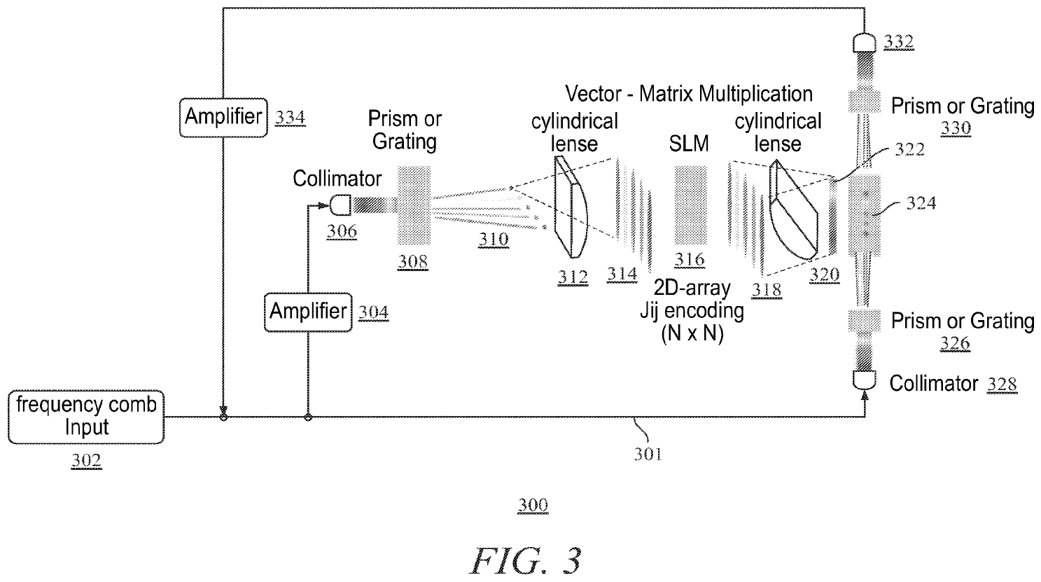

FIG. 3 depicts an illustrative an all-optical CIM 300, according to example embodiments of this disclosure. The all-optical CIM 300 may support both frequency domain multiplexing and spatial domain multiplexing. In addition, the all-optical CIM 300 may support an additional time domain multiplexing and an additional spatial domain multiplexing. The frequency domain multiplexing may be enabled by the frequency comb, in which each comb line encodes a corresponding spin information, passing through an optical fiber. The spatial domain multiplexing may be supported by free space optics (e.g., by using a prism or grating) that separates the frequencies in space. In the shown all-optical CIM 300, the linear vector matrix multiplication may also be performed in the optical domain.

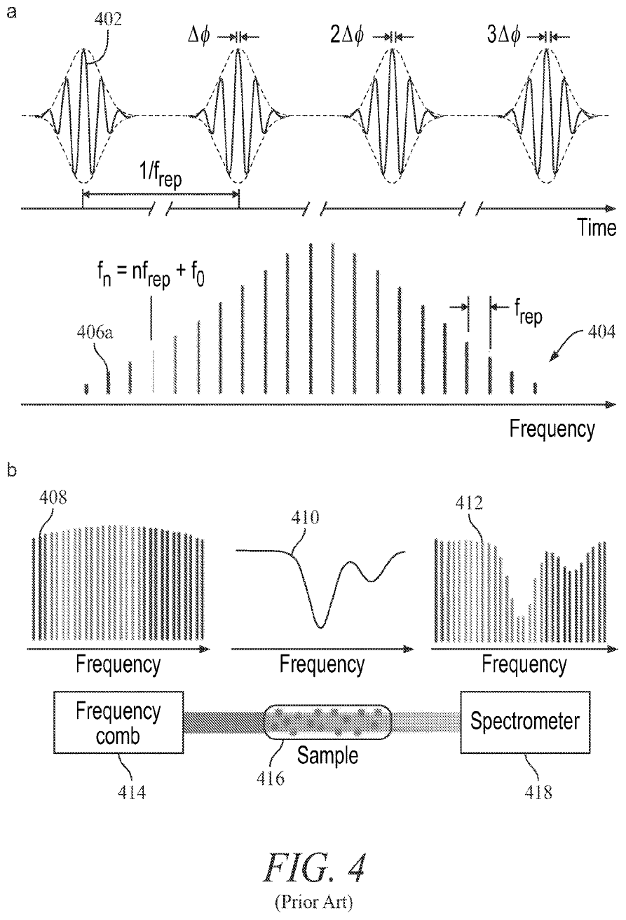

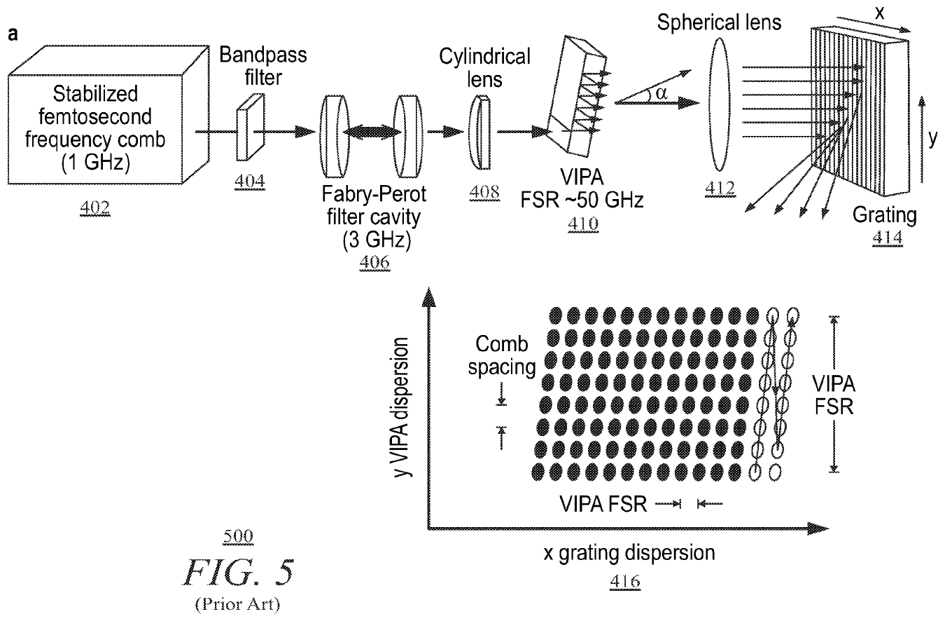

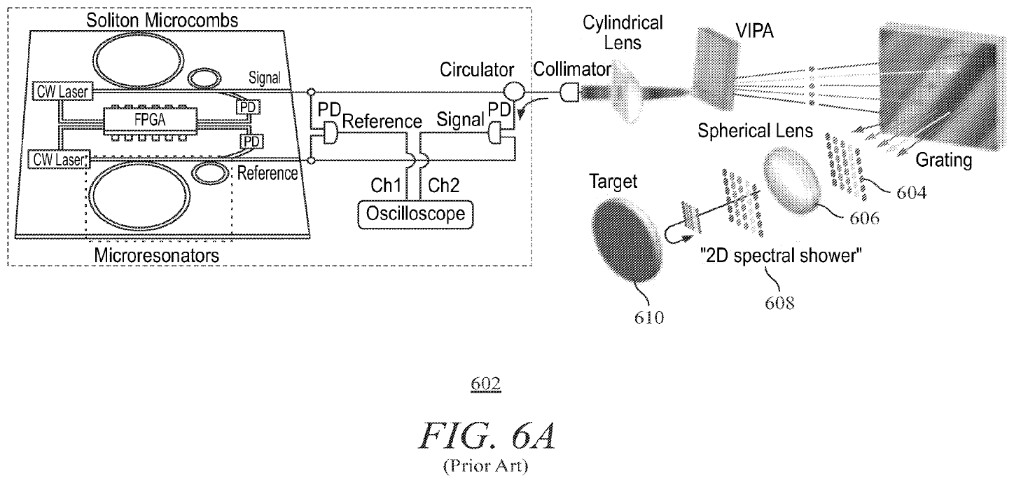

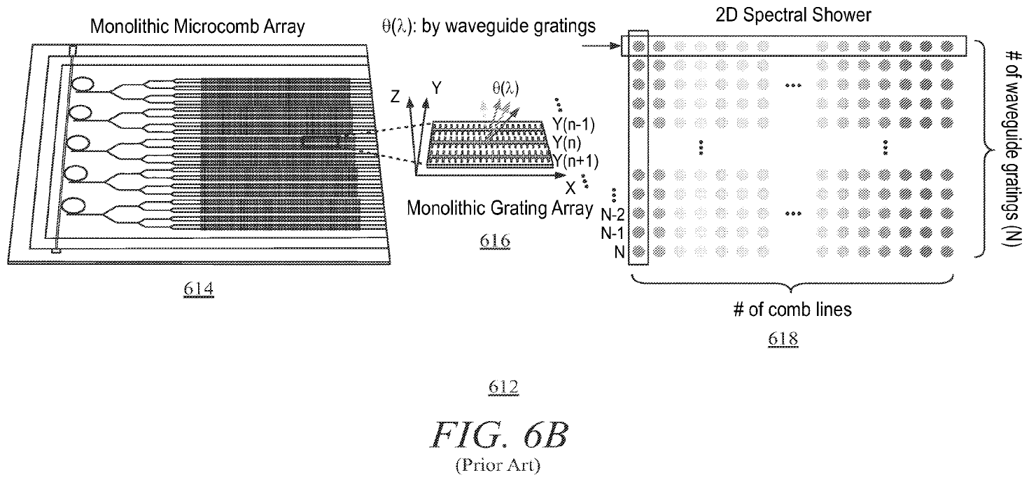

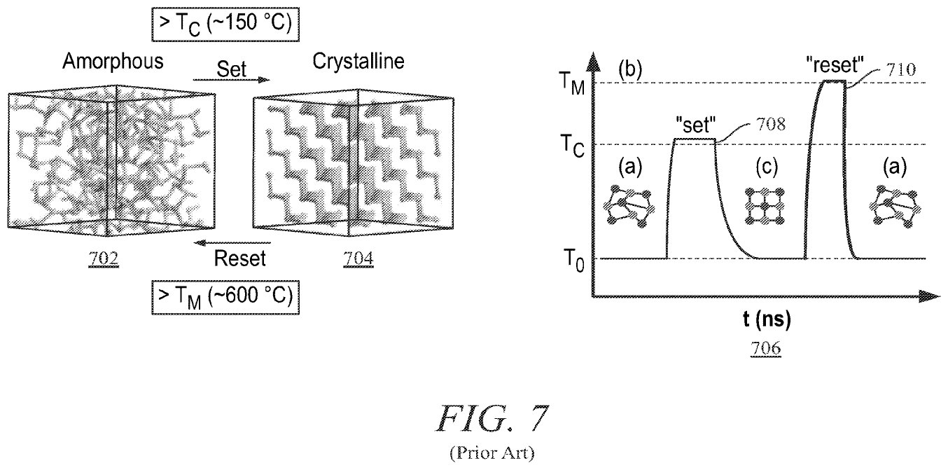

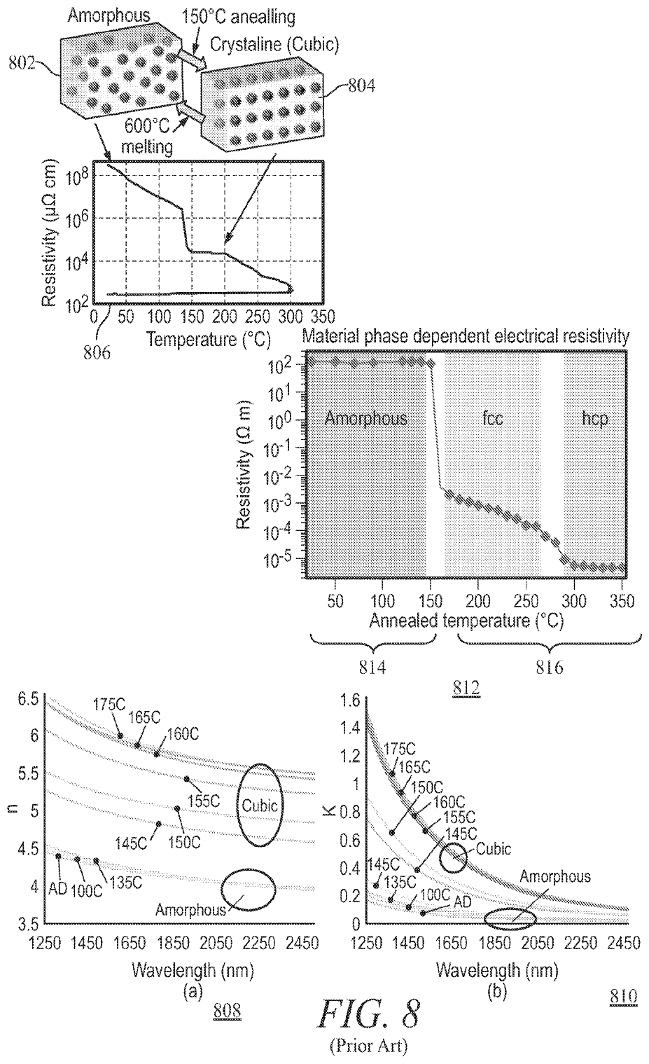

For solving the Ising problem, a spatial light modulator (SLM) 316 may be loaded with the N×N matrix through any kind of electronic mechanism. The elements of N×N matrix, forming a spin-spin interaction matrix (i.e., Jᵢⱼ matrix), may be represented as different attenuation levels of light intensity in corresponding SLM pixel elements. The frequency comb input 302, as described above, may encode the spin information. In some embodiments, the frequency comb input 302 may be generated by a mode-locked laser. The frequency comb input 302 is frequency multiplexed, because each comb line is at a different frequency and encoding a particular spin information (see FIG. 4 and the corresponding description below describing the principles of frequency comb based encoding). Because the fiber optics forming a cavity 301 provides a transmission medium for the frequency comb input 302, it can be said that the frequency domain multiplexing is provided in the fiber optics domain. The frequency comb input 302 may then be passed to a collimator 306, which may cause the frequency comb input to be substantially parallel while being incident on a prism (or grating) 308. The collimator 306 may therefore cause the frequency comb input to hit the prism 308 substantially perpendicularly, which may be desired for a cleaner separation of the frequencies in the spatial domain. The prism 308 may optically cause the frequency comb input 302 to separate—in space—into its constituent frequencies to generate a spatially separated frequency comb 310 (FIGS. 5, 6A-6B below describe principles of spatial multiplexing of frequency combs). This spatial separation of the frequencies in space therefore provides a spatial domain multiplexing when the frequency comb input 302 interacts with the spin-spin interaction matrix. The spatially separated frequency comb 310 may then pass through a cylindrical lens 312, which may then stretch each constituent frequency to generate stretched spatially separated frequency comb 314. The stretched spatially separated frequency comb 314 may be used for a vector matrix multiplication between the encoded spin information and the spin-spin interaction matrix loaded in the SLM 316. After this vector-matrix multiplication, the result 318 may pass through a cylindrical lens 320 that may re-focus the result 318 to the single stretched output 322. The output 322 is the summed intensities of light, which may therefore represent the output vector generated as a result of the matrix-vector multiplication (MVM) in the optical domain by using the SLM 316. The MVM output 322 may be projected into a medium that can be optically detected. As an example, an array of phase change material (PCM) pixels 324 may be used as the medium. The PCM (whose principles are described with reference to FIGS. 7-8 below) may change its material phase between amorphous and crystalline based on the temperature, which may be influenced by the light intensity of the MVM output 322 in the corresponding pixels.

The change in the optical properties of the PCM 324 may change the intensity of a frequency comb (initially the frequency comb input 302) passing through a collimator 328 and then to a prism (or grating) 326, which may spatially separate the frequency comb (which is frequency multiplexed) into its constituent frequencies. Each of the spatially separated frequencies may be mapped to a corresponding pixel in the PCM 324. A spatially separated frequency may pass through its corresponding pixel in the PCM 324 picking up the change in the optical property, if any, caused by the MVM output 322. At the other side of the PCM 324, a prism (or grating) 330 may combine the spatially separated frequencies (now with the information captured from the PCM), which may then pass through the collimator 332 for parallelization and onto the cavity 301. The frequency comb therefore cycles through the cavity 301, picking up the optical changes in the PCM 324 and providing a feedback input to the optical vector matrix multiplication (i.e., using SLM 316 that encodes the spin-spin interaction matrix). Instead of using the prism (or grating) 330 and the collimator 332, a mirror and optical circulator may be used with the prism (or grating) 326 and the collimator 328 to collect the spatially-multiplexed frequency comb back to the optical fiber.

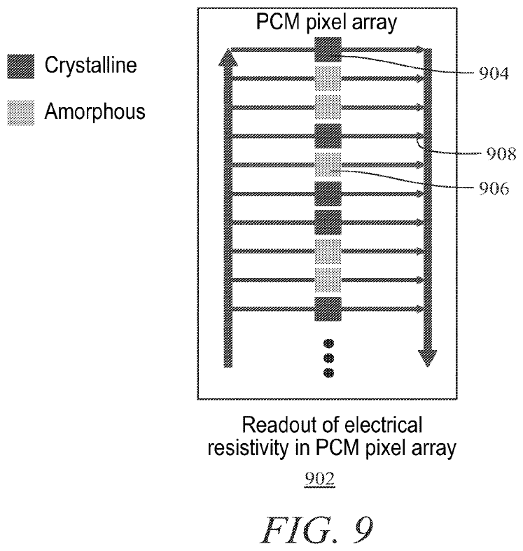

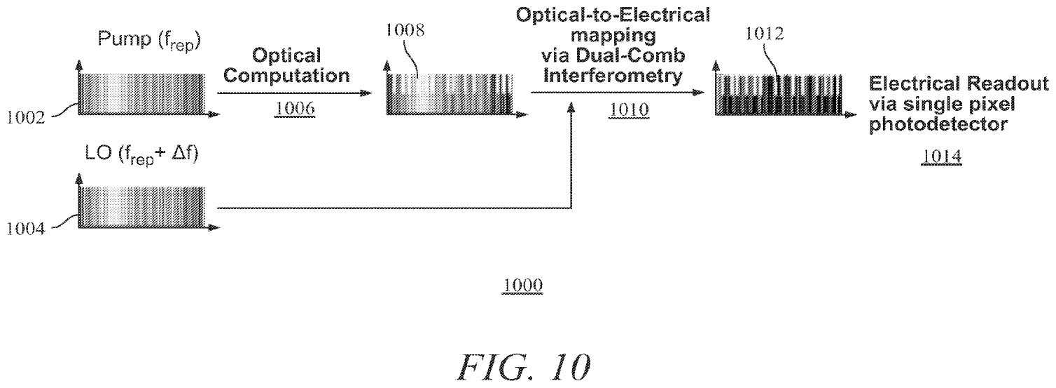

At the beginning, the optical and electrical state of the PCM 324 may set to be a certain intermediate state with an uncertainty of thermal fluctuations. The uncertainty may continue throughout the beginning cycles of the frequency comb (encoding the spin information) in the cavity. The Ising problem may be considered solved when each pixel in the PCM 324 reaches a known, detectable state (e.g., one of two binary states) indicating that a low energy steady state of the spins has been reached given the spin-spin interaction matrix. Some example detections are described in reference to FIGS. 9 and 10 below). It should however be understood that the PCM 324 is just but an example any kind of material that can capture the convergence of a solution of the Ising problem through the results of the matrix vector multiplications should be considered within the scope of this disclosure. For example, a photodetector pixel array with modulators may be used instead of the PCM 324.

FIG. 4 depicts an information mapping using optical frequency combs, as known in the art. Principles from FIG. 4, as described herein, may be used to generate frequency comb input 302 in FIG. 3. The optical frequency combs may provide frequency multiplexing, because multiple pieces of information (or different portions of the same information) can be encoded parallelly into different frequency combs. The example use case as shown is spectroscopy. An information carrying signal 402 is shown in time domain. As shown, the signal 402 may include periodic pulses, with each successive pulse slightly phase shifted (by Δφ in this example) from the corresponding earlier pulse. The signal 402 may have a frequency domain representation 404. The frequency domain representation 404 may include a frequency comb structure with multiple frequency lines (as example is referenced as 406a). The frequency lines may be equidistant from each other (i.e., in the frequency domain). As shown, the distance between each of the frequency lines is fᵣₑₚ and therefore a frequency of the n^{th} line (fₙ) may be calculated by fₙ=nfᵣₑₚ+f₀, assuming n starts from 0 (i.e., n=0 for f₀).

A frequency comb may be used to encode information in the frequency domain. As shown, a frequency comb 408 (which may be similar to the frequency domain representation 404) may be used to superimpose (or for performing any other type of operation) an information signal 410 in frequency domain. The signal 410 may have a frequency selective interaction with the frequency comb 408, e.g., attenuating different frequencies by different amounts to generate a combined signal 412 in the frequency domain. Optical phase of each frequency comb line may also change due to the interaction. An example use case of this encoding is shown as a frequency comb 414 interacting with a sample 416 to pick up characterization of the sample 416, which may then be measured using a spectrometer 418.

The frequency combs described above (e.g., frequency comb 408) encode information in frequency domain. Frequency combs, however, may be expanded to encode or decode information in other domains (e.g., 2-dimensional spatial domain).

FIG. 5 depicts a process 500 of dispersing frequency combs in two-dimensional spatial domain, as known in the art. Principles from FIG. 5, as described herein, may be used to generate a spatially separated frequency comb 310 in FIG. 3. At step 502, a signal generator may generate an optical signal. At step 504, the generated signal may be passed through a bandpass filter to select a frequency band for downstream processing. After the bandpass filtering, the filtered signal may be passed through a Fabry-Perot filter cavity in step 506. The Fabry-Perot filter cavity may allow a subset of wavelengths to pass through using constructive interference within the cavity, while filtering out the other wavelengths through destructive interference. At step 508, the signal may pass through a cylindrical lens (e.g., cylindrical lens 312 as shown in FIG. 3). At step 510, the light may pass through a virtually imaged phased array (VIPA) which may split the signal into its different spectral (i.e., frequency) components. The cylindrical lens and the VIPA may perform equivalent function as the cylindrical lens 312 shown in FIG. 3. More generally, the signal generator, the bandpass filter, the Fabry-Perot filter cavity, VIPA, and the cylindrical lens may function as different components generating the frequency comb input 302 shown in FIG. 3. At step 512, the split signal may be passed through a spherical lens for parallelizing the split signal and the parallelized split signal may be incident on a grating to disperse the optical frequency comb in two-dimensional spatial domain 516. Each dot represents a comb line having different frequency. In some examples, the two-dimensional frequency comb 516 may have more than 1000 frequency comb lines. In the two-dimensional frequency comb 516, an x-directional dispersion may be generated through the grating step 514 and an y-directional dispersion may be generated through the VIPA step 510. The two-dimensional frequency comb 516 may then be used to encode/decode (or map) any type of information in two-dimensional spatial domain, where the information mapping may be based on selective attenuation or optical phase change of some frequencies in the two-dimensional frequency comb 516.

The two-dimensional frequency comb (e.g., two-dimensional frequency comb 516) is also referred to as a two-dimensional spectral shower, which may be used for spatial imaging. For example, FIG. 6A depicts a process 602, as known in the art, of taking a two-dimensional frequency comb 604 (similar to the two-dimensional frequency comb 516 shown in FIG. 5), passing it through a spherical lens 606 to focus as the two-dimensional spectral shower 608 on a target 610. Principles from FIG. 6A, as described herein, may be used to generate a spatially separated frequency comb 310 in FIG. 3. Two-dimensional spatial information on the target 610 may therefore be mapped into the two-dimensional spectral shower 608.

FIG. 6B depicts a process 612 of generating a two-dimensional spectral shower, as known in the art. Principles from FIG. 6B, as described herein, may be used to generate a spatially separated frequency comb 310 in FIG. 3. As shown, within a monolithic microcomb array 614 a two-dimensional frequency comb line may be generated. The generated two-dimensional frequency comb may then be dispersed through a monolithic grating array 616 within the monolithic microcomb array 614 to generate multiple copies of the one-dimensional frequency comb to form two-dimensional spectral shower 618. It should therefore be understood that the spatial domain multiplexing may increase the number of pixels in the two-dimensional spectral showers 608 and 618.

FIG. 7 depicts operation of a PCM as known in the art. Principles from FIG. 7, as described herein, may be used to implement PCM 324 as a non-volatile memory configured to capture the Ising solution in FIG. 3. The example PCM material shown is Ge₂Sb₂Te₅ (GST), which may interchange between an amorphous state 702 and a crystalline state 704 based on the temperature. For instance, temperature (T_{C}) of about 150° C. may cause the GST to change to a crystalline state 704 and a temperature (T_{M}) of about 600° C. may cause the GST to change to an amorphous state 702. Therefore, as shown in the graph 706, heating the GST to around T_{C} may be “setting” the GST to a crystalline state and heating the GST to around T_{M} may be “resetting” the GST to its amorphous state. The heating may be performed through an optical actuation providing short pulses. The optical actuation may be the result of the feedback provided by vector matrix multiplication described in reference to FIG. 3 above. Because the GST may reach a steady state (e.g., settling on one of the two states) based on the results of the iterative vector matrix multiplication, where the steady state may be detected, the steady state may be referred to as the solution of the Ising problem.

FIG. 8 depicts the changes in electrical and optical properties of PCM based on temperature, as known in the art. Principles from FIG. 8, as described herein, may be used to implement PCM 324 as a non-volatile memory configured to capture the Ising solution in FIG. 3. As shown, the material used for PCM may include GST. When the PCM changes from an amorphous state 802 to a crystalline (or cubic) state 804, the resistivity decreases and vice versa, as shown by the graph 806. Furthermore, as shown in the graphs 808 (depicting a real portion, n, of the complex refractive index n−jκ) and 810 (depicting an imaginary portion, κ, of the complex refractive index n−jκ), the refractive index may have different properties based on whether the PCM is in crystalline state or amorphous state. Therefore the state of the PCM can be detected electrically and/or optically, which may then be used to determine the solution of the Ising problem. Furthermore, graph 812 shows the change in electrical resistivity based on the material state (also referred to as material phase) of PCM. A first portion 814 associated with the amorphous state (or phase) of the PCM may have high resistivity and a second portion 816 associated with the crystalline state (or phase) of the PCM may have a low resistivity.

FIG. 9 depicts an illustrative electrical readout scheme of PCM states, according to example embodiments of this disclosure. For example, based on the principles of the graph 812, a PCM array 902 may be constructed with spatially separated pixels. As shown pixel 904 may have a crystalline state while pixel 906 may have amorphous state. Electrical resistivity of the pixels may be detected by passing current through the wires (an example wire is labeled as 908).

FIG. 10 depicts an illustrative multiple heterodyne (dual-comb) readout 1000 of the solution of the Ising problem, according to example embodiments of this disclosure. The frequency comb 1002 may be used for optical computation 1006 (e.g., to determine a solution of the Ising problem) to generate a result 1008 (indicating the solution of the Ising problem). In the result 1008, some frequency lines in the frequency comb 1002 may be attenuated to indicate, e.g., a “0” binary state, while other frequency lines may not be attenuated to indicate, e.g., a “1” binary state. Another frequency comb 1004 may be generated as a local oscillator, which may then be combined with the result 1008, and the combination may be used for an optical-to-electrical information mapping via dual-comb interferometry 1010. Here, readout of the electrical comb 1012 may be possible via a single pixel photodetector 1014.

In addition to frequency domain multiplexing supported by the disclosed optical CIM (e.g., all-optical CIM 300 shown in FIG. 3), the properties of PCM may allow for an additional time domain multiplexing. The material phase (or state) transition time of PCM may be very short: crystallization may be achieved in a few nanoseconds and amorphization may be achieved in sub nanoseconds. This quick phase change may be used to set and reset the PCMs for the optical CIM to support an additional time domain multiplexing for solving different Ising problems.

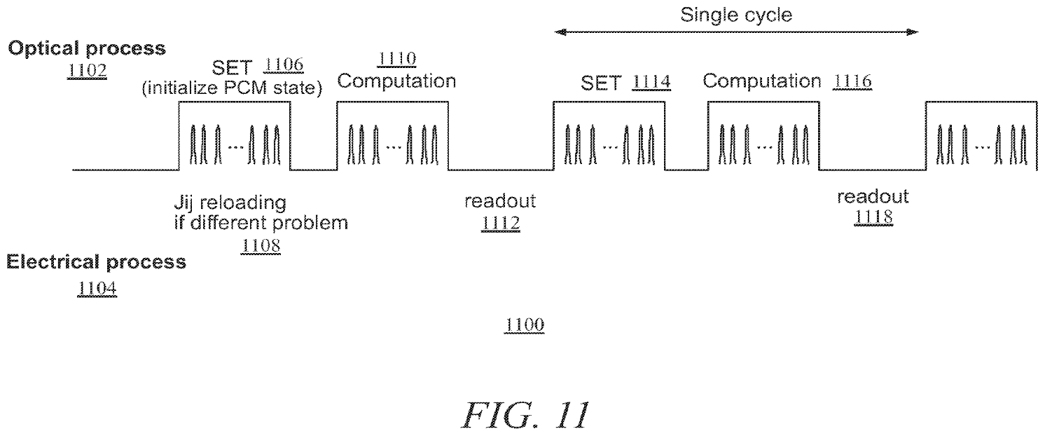

FIG. 11 depicts an illustrative process 1100 of a time domain multiplexing, according to example embodiments of this disclosure. As shown, the process 1100 may be divided into an optical process 1102 and electrical process 1104. The calculations may be performed in the optical domain by using the optical process 1102 and the input/output may be performed in the electrical domain using the electrical process 1104. At the beginning of a cycle, the PCM states may be optically set at step 1106. If the current cycle is for a different Ising problem than the previous cycle, an SLM may be reloaded electrically with j spin-spin interaction matrix at step 1108. The computation may be performed, optically, at step 1100. The readout of the computation may be readout electrically (e.g., through the measurement of resistivities of the individual pixels) at step 1112. Another cycle may begin where the PCM states may be optically set at step 1114. Assuming that this cycle is for the solving same Ising problem, the SLM may not have to be loaded with another spin-spin interaction matrix. The optically computation may be performed at step 1116 and the results may be readout at step 1118. Each cycle therefore may take at a particular interval of time and the temporally staggering the cycle may enable a time domain multiplexing in addition to the frequency domain multiplexing provided by frequency combs traveling through the fiber optics.

In addition to the frequency domain multiplexing in the frequency comb traveling through fiber optics and spatial domain multiplexing provided by free space optics, and also in addition to the time domain multiplexing provided by resetting PCM, an all-optical CIM may provide an additional spatial domain multiplexing by using multiple optical fibers. To support the additional spatial domain multiplexing, the number of pixels in an SLM array and the PCM array may have to be increased, as described below.

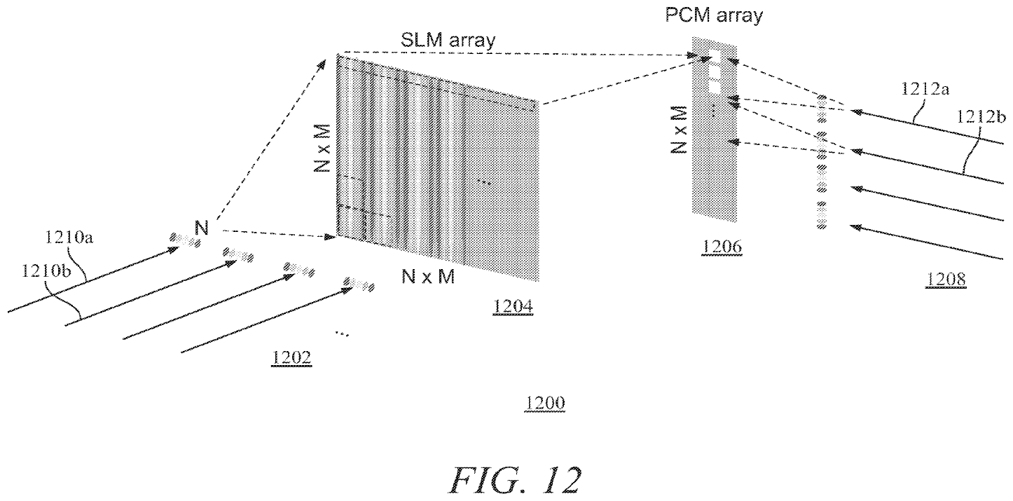

FIG. 12 depicts an illustrative process 1200 of an additional spatial domain multiplexing, according to example embodiments of this disclosure. As shown N corresponds to a number of comb lines and M corresponds to a number of optical fibers. Each optical fiber may therefore carry N number of comb lines thereby increasing the pixel size of both the SLM array and the PCM array to N×M. As shown, each of the M optical fibers 1202 (two of them have been labeled as 1210a and 1210b) may provide N comb lines to the N×M SLM array 1204. After the vector matrix multiplication in the SLM array 1204, the results may be captured by N×M PCM array 1206 (FIG. 12 shows one columns of the PCM array 1206). The results in the PCM array may then optically captured by M optical fibers 1208 (two of which have been labeled as 1212a and 1212b) for circulating in the cavities formed by the corresponding optical fibers 1208.

Therefore, the embodiments disclosed herein may support any kind of multiplexing to generate a high throughout all-optical CIM. Furthermore, the number of Ising spins (e.g., the number of pixels in the PCM array) may be scaled up to solve N=10⁵ problem, which may roughly correspond to the SLM array size of a 60-inch LCD panel. Furthermore, the energy consumption to solution also is low based on the embodiments disclosed herein. For example, with the energy consumption of 1.8 nJ per 0.12 μm³, the upper bound of energy consumption for N=1000 may generally be less than 1.5 mJ. The energy consumption for electrical loading of the Jᵢⱼ matrix (i.e., spin-spin interaction matrix) and the electrical readout of the PCM array resistivity may be considered negligible. (The additional energy consumption may be from the mode-locked laser, which may consume less than 10 W and optional optical amplifiers, which may consume about 3 W).

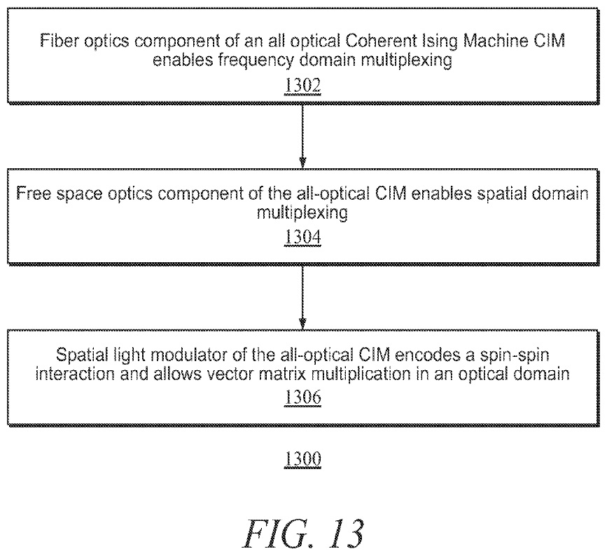

FIG. 13 depicts a flow diagram of an illustrative method 1300 implemented by an all-optical CIM, according to example embodiments of this disclosure. It should be understood that the steps of the method 1300 are just intended as non-limiting examples, and methods with additional, alternative, or fewer number of steps should be considered within the scope of this disclosure.

The method 1300 may begin at step 1302 where a fiber optics component of the all-optical CIM may enable frequency domain multiplexing. The frequency domain multiplexing may be enabled by the fiber optics component providing a transmission medium for a plurality of comb lines of a frequency comb mapped into a spin vector. At step 1302, a free space optics component of the all-optical CIM may enable spatial domain multiplexing. The spatial domain multiplexing may be enabled by the free space optics component by spatially separating the plurality of comb lines of the frequency comb. At step 1306, a spatial light modulator of the all-optical CIM that may encode a spin-spin interaction may allow for a vector matrix multiplication to solve an Ising problem. The vector matrix multiplication may between the spatially separated plurality of comb lines mapped to the spin vector and the spin-spin interaction matrix. The result of the vector matrix multiplication may provide a linear feedback to solve the Ising problem

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. An all-optical Coherent Ising Machine (CIM), comprising:
a fiber optics component configured to enable a frequency domain multiplexing by providing a transmission medium for a plurality of comb lines of a frequency comb mapped into a spin vector;
a free space optics component configured to enable a spatial domain multiplexing by spatially separating the plurality of comb lines of the frequency comb; and
a spatial light modulator configured to encode a spin-spin interaction matrix and allowing for a vector matrix multiplication, in an optical domain, of the spatially separated plurality of comb lines mapped to the spin vector and the spin-spin interaction matrix, wherein a result of the vector matrix multiplication provides a linear feedback to solve an Ising problem.

2. The all-optical CIM of claim 1, further comprising:
a phase change material array configured to capture the result of the vector matrix multiplication in the optical domain as summed optical intensities in corresponding pixels.

3. The all-optical CIM of claim 2, wherein the fiber optics component is further configured to provide an optical feedback loop for the result of the vector matrix multiplication.

4. The all-optical CIM of claim 2, further comprising:
an electrical reading circuit configured to measure resistivities of the pixels of the phase change material array, the resistivities being based on corresponding pixel temperature adjusted by the summed optical intensities captured by the corresponding pixels.

5. The all-optical CIM of claim 1, further comprising:
a single pixel detector configured to read intensities of the plurality of comb lines, corresponding to binary states, based on the result of the vector matrix multiplication via multiple heterodyning.

6. The all-optical CIM of claim 1, wherein the spatial light modulator is configured to be electrically loaded with the spin-spin interaction matrix.

7. The all-optical CIM of claim 1, further configured to provide a time domain multiplexing by:
resetting pixels of a phase change material array between a first Ising computation and a second Ising computation.

8. The all-optical CIM of claim 1, further comprising:
additional fiber optics components enabling additional parallel frequency combs to provide an additional spatial domain multiplexing.

9. The all-optical CIM of claim 2, further comprising:
an additional free space optics component configured to focus the summed optical intensities into a corresponding pixel of the phase change material array.

10. The all-optical CIM of claim 1, further comprising:
an additional free space optics component configured to provide a frequency comb to the spatial light modulator.

11. A method implemented by an all-optical Coherent Ising Machine (CIM), the method comprising:
enabling, by a fiber optics component of the all-optical CIM, frequency domain multiplexing by providing a transmission medium for a plurality of comb lines of a frequency comb mapped into a spin vector;
enabling, by a free space optics component of the all-optical CIM, a spatial domain multiplexing by spatially separating the plurality of comb lines of the frequency comb; and
allowing, by a spatial light modulator of the all-optical CIM and encoding a spin-spin interaction, a vector matrix multiplication, in an optical domain, of the spatially separated plurality of comb lines mapped to the spin vector and the spin-spin interaction matrix, wherein a result of the vector matrix multiplication provides a linear feedback to solve an Ising problem.

12. The method of claim 11, further comprising:
capturing, by a phase change material array of the all-optical CIM, the result of the vector matrix multiplication in the optical domain as summed optical intensities in corresponding pixels.

13. The method of claim 12, further comprising:
providing, by the fiber optics component, an optical feedback loop for the result of the vector matrix multiplication.

14. The method of claim 12, further comprising:
measuring, by an electrical reading circuit of the all-optical CIM, resistivities of the pixels of the phase change material array, the resistivities being based on corresponding pixel temperature adjusted by the summed optical intensities captured by the corresponding pixels.

15. The method of claim 12, further comprising:
focusing, by the free space optics component, the summed optical intensities into a corresponding pixel of the phase change material array.

16. The method of claim 11, further comprising:
reading, by a single pixel detector of the all-optical CIM, intensities of the plurality of comb lines, corresponding to binary states, based on the result of the vector matrix multiplication via multiple heterodyning.

17. The method of claim 11, further comprising:
electrically loading the spin-spin interaction matrix to the spatial light modulator.

18. The method of claim 11, further comprising:
resetting pixels of a phase change material array between a first Ising computation and a second Ising computation to provide a time domain multiplexing.

19. The method of claim 11, further comprising:
enabling, by additional fiber optics components of the all-optical CIM, additional parallel frequency combs to provide an additional spatial domain multiplexing.

20. The method of claim 11, further comprising:
providing, by an additional free space optics component of the all-optical CIM, a frequency comb mapped to an input vector to the spatial light modulator.
